(19) United States
(12) Patent Application Publication
(10) Pub. No.: US 2007/0114952 A1
(43) Pub. Date: May 24, 2007

(54) Light source driver circuit

(76) Inventor: Hui-Qiang Yang, Sijhih City (TW)

Correspondence Address: SCHMEISER, OLSEN & WATTS, 22 CENTURY HILL DRIVE, SUITE 302, LATHAM, NY, 12110, US

(21) Appl. No.: 11/283,201

(22) Filed: Nov. 18, 2005

(51) Int. Cl. H05B 41/36

(52) U.S. Cl. 315/307

(57) ABSTRACT

The present invention provides a light source driver circuit for improving power conversion efficiency and avoiding a high cost due to the requirements of safety regulations. The light source driver circuit comprises a pulse width control circuit that uses an AC power supply to produce a square wave; a first transformer having a primary winding for inputting the square wave and a secondary winding for outputting a transformation square wave; a resonant circuit that inputs the transformation square wave for producing a resonance sine wave; and a second transformer having a primary winding for inputting the resonance sine wave and a secondary winding for outputting a transformation sine wave to drive a light source.

### FIELD OF THE INVENTION

The present invention relates to a light source driver circuit, and more particularly to a light source driver circuit that provides a high efficiency of power conversion and avoids a high cost incurred by the requirements of the safety regulations.

### BACKGROUND OF THE INVENTION

Referring to FIG. 1 for the schematic diagram of a prior art light source driver circuit applied to a liquid crystal display (LCD) backlight module, an alternate current 1 (AC 50/60 Hz) is converted into a low voltage DC output power DCOP by an AC-to-DC converter 2, and that voltage is usually between 12 volts to 36 volts, and the power of the DC output power DCOP is converted into a high-frequency AC power by a DC input inverter 3, and that power usually has a voltage of 500 volts to 1500 volts and a frequency of 100 KHz for driving a light source device 4 such as a cold cathode fluorescent lamp.

Referring to FIG. 2 for the schematic view of a switch power supply, an example of the aforementioned prior art AC-to-DC converter includes an input AC power supply 5 (AC 50/60 Hz) comprising a rectifier circuit of a rectifier filter 6 and a capacitor 7, a pulse width control circuit 8, a transformer T1, a secondary rectifier filter circuit 9 and a feedback control circuit 10. The switch power supply converts city electricity into a direct current required by the prior art DC input inverter.

Referring to FIG. 3 for an example of the prior art DC input inverter, the DC input inverter comprises a DC input power, a pulse width control circuit 11 of the DCIP, a resonant circuit 12, a transformer T2 and a feedback control circuit 13. The function of the resonant circuit 12 is to produce an AC power (AC voltage or alternate current) and step up the voltage by the transformer T2 or not step up the voltage by the transformer to drive the light source device 14 such as a cold cathode fluorescent lamp. The pulse width control circuit 11 provides power to drive the resonant circuit 12 to produce an AC voltage or an alternate current, and such power could be in form of a voltage or a current. The signal of the feedback control circuit 13 is fed back for controlling the power supplied by the pulse width control circuit 11 and further controlling the AC power supply produced by the resonant circuit 12 to achieve the effect of modulating light.

The foregoing prior art light source driver circuit has the following drawbacks:
1. The total efficiency is low. Since the prior art light source driver circuit comprises an AC-to-DC converter and an inverter, and the efficiency of the present AC-to-DC converter is approximately 85% (0.85), therefore the efficiency of the prior art light source driver circuit is approximately 0.85×0.85=0.7225(72.25%).
2. Referring to FIG. 3 for the DC input inverter, the input voltage usually ranges from 5 volts to 30 bolts. If a rectifier filter circuit (not shown in the figure) is installed to the DCIP of the DC input power, the same effect of the prior art DC input inverter can be achieved theoretically and its efficiency is even higher than the foregoing prior art circuit. However, the safety distance between the primary and seconding windings of the transformer T2 should be at least 16˜18 mm according to the requirements of safety regulations and should be able to pass a HI-POT Test of 25K volts. Thus, it will be difficult to make such DC input inverter and its cost will be high.

### SUMMARY OF THE INVENTION

In view of the shortcomings of the prior art, the present invention provides a light source driver circuit that provides a high power conversion efficiency and avoids a high cost incurred by the requirements of safety regulations.

Therefore, it is a primary objective of the present invention to provide a light source driver circuit comprising: a pulse width control circuit that uses an AC power supply to produce a square wave; a first transformer having its primary winding for inputting the square wave and its secondary winding for outputting a transformation square wave; a resonant circuit that inputs the transformation square wave to produce a resonance sine wave; and a second transformer having its primary winding for inputting the resonant sine wave and its secondary winding for outputting a transformation sine wave to drive a light source.

### BRIEF DESCRIPTION OF THE DRAWINGS

FIG. 1 is a schematic diagram of a prior art light source driver circuit;

FIG. 2 is a schematic diagram of a prior art switch power supply;

FIG. 3 is a schematic diagram of a prior art DC input inverter;

FIG. 4 is a schematic diagram of a light source driver circuit according to a first preferred embodiment of the present invention;

FIG. 5 is a schematic diagram of a light source driver circuit according to a first preferred embodiment of the present invention;

FIG. 6A is a schematic diagram of a light source driver circuit according to a second preferred embodiment of the present invention;

FIG. 6B is a schematic diagram of waveforms according to a second preferred embodiment of the present invention; and

FIG. 7 is a schematic diagram of waveforms according to a third preferred embodiment of the present invention.

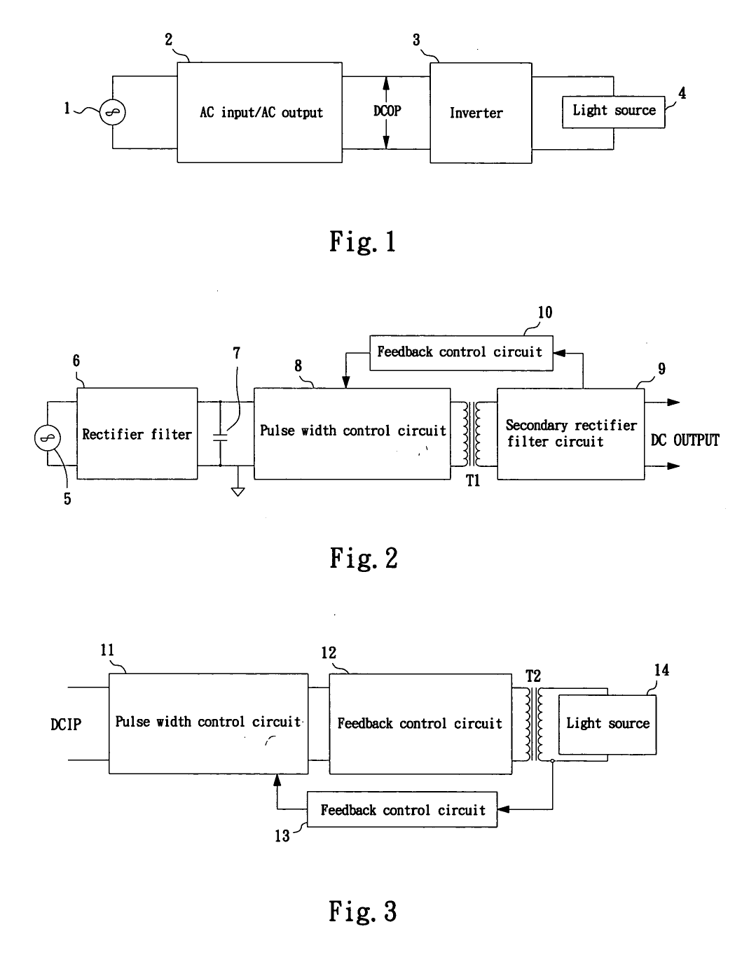

### DETAILED DESCRIPTION OF THE PREFERRED EMBODIMENTS

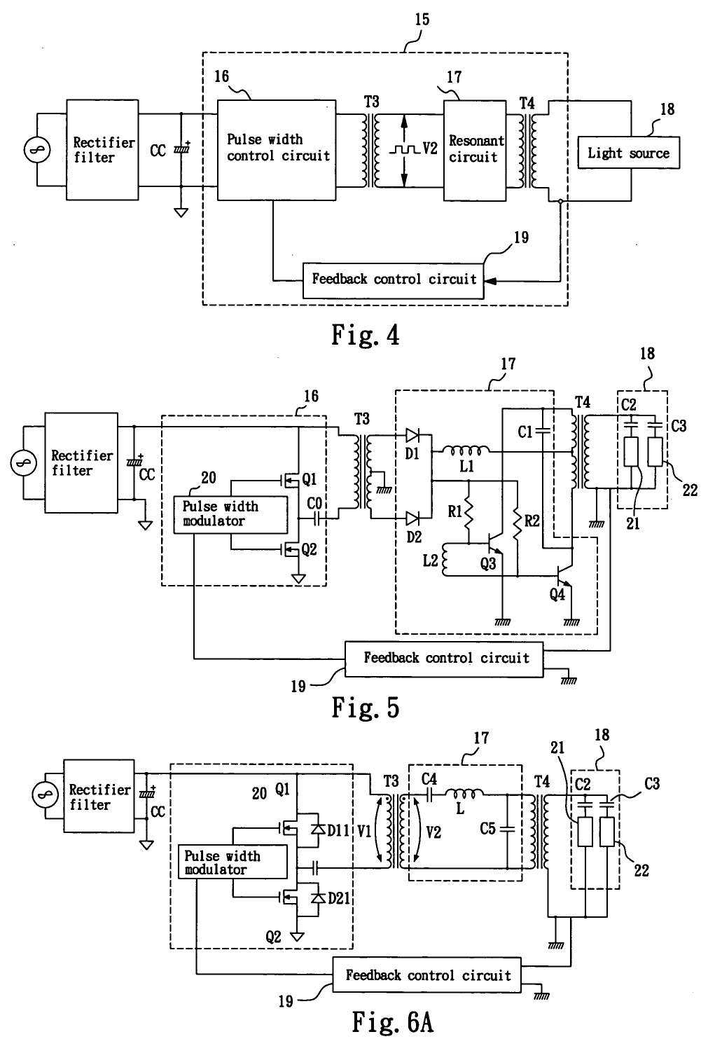

Referring to FIG. 4 for the schematic diagram of a light source driver circuit according to a first preferred embodiment of the present invention, the light source driver circuit 15 comprises a pulse width control circuit 16 that uses an AC power supply to produce a square wave, and the AC power supply could be city electricity passing through a rectifier filter circuit having a rectifier filter and a rectifier capacitor CC; a first transformer T3 having its primary winding for inputting the square wave and its secondary winding for outputting a transformation square wave V2; a resonant circuit 17 for inputting the transformation square wave V2 to produce a resonant sine wave; a second transformer T4 having its primary winding for inputting the resonant sine wave and its secondary winding for outputting a transformation sine wave to drive the light source device 18, and the light source device 18 could be a light source of an LCD backlight module; and a feedback control circuit 19 that uses the transformation sine wave to produce a feedback to a feedback signal of the pulse width control circuit 16.

Compared with the prior art light source driver, the light source driver circuit of the present invention simplifies and combines the two sets of pulse width control circuits and the two sets of feedback control circuits (respectively used in the switch power supply and the DC input inverter), and only uses one set of pulse width control circuit and one set of feedback control circuit. In the meantime, the secondary rectifier filter circuit of the switch power supply is simplified or omitted, and the first transformer T3 converts the high voltage of a general rectified city electricity into a low voltage (defined as DC 42 volts or AC 30 volts by the safety regulations) and then converts the low voltage square wave into a sine wave voltage or current directly by the resonant circuit, and finally outputs the current to drive a light source device 18 such as a cold cathode fluorescent lamp after the voltage is boosted by the second transformer T4. Therefore, the light source driver circuit of the present invention has a higher efficiency and a lower manufacturing cost than the prior art light source driver circuit. Furthermore, the present invention can avoid the aforementioned safety regulation issue.

Referring to FIG. 5 for the schematic diagram of a light source driver circuit according to a first preferred embodiment of the present invention, the resonant circuit is connected in parallel. In FIGS. 4 and 5, the light source driver circuit of the invention comprises a pulse width control circuit 16 for inputting city electricity through a rectifier filter circuit including a rectifier filter and a rectifier capacitor CC, a pulse width modulator 20, two current switches Q1, Q2, and a capacitor C0; a first transformer T3 having its primary winding for inputting a square wave produced by the pulse width control circuit 16 and its secondary input transformation square wave V2 complies with the low-voltage requirement of the safety regulations; a resonant circuit 17 for inputting the transformation square wave V2 through the rectifier diode D1, D2 and includes a resonant inductor L1, L2, a resonant capacitor C1, and a rectifier transistor Q3, Q4 controlled by the signals produced respectively by the voltage divider resistor R1, R2, so as to produce a resonant sine wave; a second transformer T4 having its primary winding for inputting the resonant sine wave and its secondary winding for outputting a transformation sine wave to drive the light source device 18, and the light source device 18 could be a light source used for an LCD backlight module and includes a cold cathode fluorescent lamp 21, 22 connected to the capacitor C2, C3 in series respectively; and a feedback control circuit 19 that uses the transformation sine wave to produce a feedback to a feedback signal of the pulse width control circuit 16.

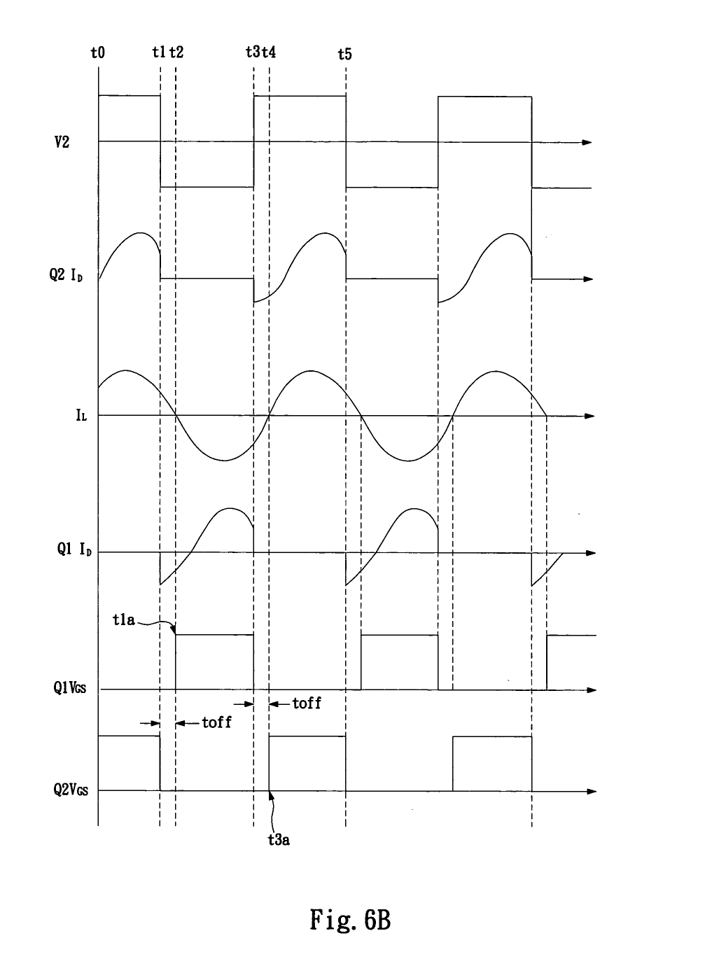

Referring to FIG. 6A for the schematic diagram of a light source driver circuit according to a second preferred embodiment of the present invention, the resonant circuit is connected in parallel. In FIGS. 4 and 6A, a light source driver circuit of the present invention comprises a pulse width control circuit 16 for inputting city electricity that passes through a rectifier filter circuit including a rectifier filter and a rectifier capacitor CC, and a pulse width modulator 20, two current switches Q1, Q2, and a capacitor C0; a first transformer T3 having its primary winding for inputting a square wave V1 produced by the pulse width control circuit 16 and its secondary input transformation square wave V2 complies with a low-voltage requirement of the safety regulations; a resonant circuit 17 including a resonant inductor L and a resonant capacitor C4, C5 to produce a resonant sine wave; a second transformer T4 having its primary winding for inputting the resonant sine wave and its secondary winding for outputting a transformation sine wave to drive the light source device 18, and the light source device 18 could be a light source used for an LCD backlight module and includes a cold cathode fluorescent lamp 21, 22 connected with the capacitor C2, C3 in parallel respectively; and a feedback control circuit 19 that uses the transformation sine wave to produce a feedback to a feedback signal of the pulse width control circuit 16.

The second preferred embodiment of the present invention as shown in FIG. 6A is used for illustrating the actions of the light source driver circuit of the present invention.

Refer to 6B for the schematic diagram of waveforms according to a second preferred embodiment of the present invention. In FIGS. 6A and 6B, the city electricity is inputted from a rectifier filter circuit including a rectifier filter and a rectifier capacitor CC and the pulse width control circuit 16 outputs a square wave V1 to the primary winding of the first transformer T3 by the actions of the current switches Q1, Q2 and produces a low-voltage transformation square wave V2 of the first transformer T3 to meet the low voltage requirements of safety regulations, and the alternate current produced by the resonant circuit 17 is boosted by the second transformer T4 to drive the light source device 18. Referring to FIGS. 6A and 6B, the pulse width control circuit 16 controls the high potential of the switch signal Q2VGS between the gate and the source of the current switch within the time from t0 to t1, such that the current switch Q2 is electrically connected to input the current from the first transformer T3, the capacitor C0 and pass from the drain to the source of the current switch Q2, and finally to the ground. A voltage V1 (not shown in the figure) induced at the primary winding of the first transformer T3 goes through the first transformer T3 to induce a voltage V2 having a high potential lower than the voltage V1 at the secondary winding and has the same polarity, and the voltage V2 is applied to the resonant circuit 17 to produce a resonant sine wave through the resonant inductor L and the resonant capacitor C5. Its frequency is ½π× (the capacitance of the resonant inductor L×the capacitance of the resonant capacitor C5)½, where the time between t0 and t1 must be smaller than or equal to a half cycle of the sine wave. With the time off between t1 and t2, the pulse width control circuit 16 controls the low potential of the switch signal Q2VGS of the current switch Q2 between its gate and source, such that the current switch Q2 is not electrically connected so as to disconnect the current that passes through the first transformer T3, the capacitor C0 and from the drain to the source of the current switch Q2. Now, the resonant inductor L produces a counter electromotive force to maintain the original current direction, so as to reverse the polarity of the voltage V2 of the secondary winding of the first transformer T3 and also reverse the voltage polarity of the primary inductance of the first transformer T3. The current passes from the primary winding of the first transformer T3 through the capacitor C0 and the internal diode D11 of the current switch Q1, and then the current returns to the primary winding of the first transformer T3. In the meantime, the pulse width control circuit 16 at the time t1a between t1 and t2 controls and coverts the switch signal Q1VGS outputted between the gate and source of the current switch Q1 into a high potential, such that the current switch Q1 is electrically connected. Within the time from t2 to t3, the phase of the current IL of the resonant inductor L is in a negative half cycle due to the resonance, and the current switch is electrically connected, therefore the polarity of the current is reversed. The current passes from the primary winding of the first transformer T3 through the drain to the source of the current switch Q1 and then passes the capacitor C4 and returns to the primary winding of the first transformer T3, and the action is very similar to that occurred at the time from t0 to t1. At the time off toff from t3 to t4, the pulse width control circuit 16 controls and outputs a low potential for the switch signal Q1VGS from the gate and source of the current switch Q1, such that the current switch Q1 is not electrically connected, so as to disconnect the current originally passing through the primary winding of the first transformer T3 from the drain to the source of the current switch Q1 and then to the resonant capacitor C4. Now, the resonant inductor L produces a counter electromotive force to maintain the original current direction, so that the polarity of the voltage V2 induced at the primary winding of the first transformer T3 is reversed, and the polarity of the voltage V1 induced at the primary winding of the first transformer T3 is reversed as well. The current passes from the positive (+) end of the capacitor C3 of the primary winding of the first transformer T3 to the ground and then through the internal diode D21 and the capacitor C4 of the current switch Q2 back to the primary winding of the first transformer T3. In the meantime, the pulse width control circuit 16 at the time t3a between the t3 and t4 controls and converts the switch signal Q2VGS between the gate and the source of the current switch Q2 into a high potential, so that the current switch Q2 is electrically connected. The foregoing process is repeated to form a resonance and the second transformer T4 is boosted to drive the light source device 18.

In the light source driver circuit of the present invention, it preferably includes a current feedback control circuit 19 for producing a feedback to a feedback signal of the pulse width control circuit 16, so that the pulse width control circuit 16 can appropriately control the operating frequency of the light source driver circuit to control the change of the current outputted to the light source device 18, and can further achieve the effect of producing the required brightness of the light source device 18, and the foregoing light modulation could be in a continuous mode or a burst mode.

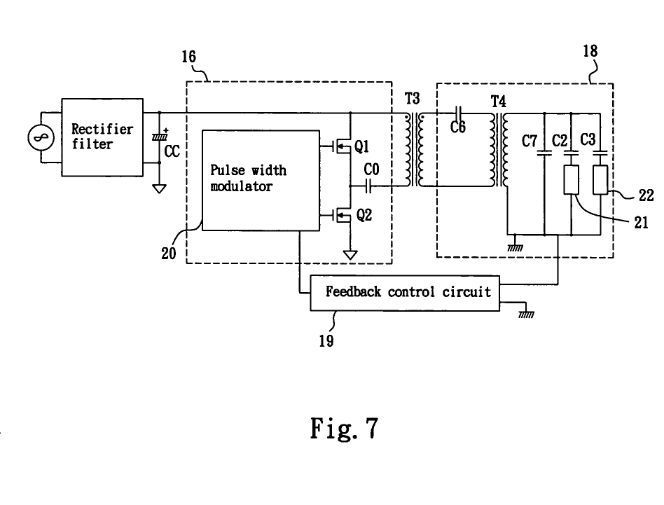

Referring to FIG. 7 for the schematic diagram of waveforms according to a third preferred embodiment of the present invention, the resonant circuit is connected in series. In FIGS. 4 and 7, a light source driver circuit of the present invention comprises: a pulse width control circuit 16 that inputs city electricity through a rectifier filter circuit including a rectifier filter and a rectifier capacitor CC and a pulse width modulator 20, two current switches Q1, Q2, and a capacitor C0; a first transformer T3 having its primary winding for inputting a square wave V1 produced by the pulse width control circuit 16 and its secondary winding for inputting a transformation square wave V2 to meet the low-voltage requirements of safety regulations; a resonant circuit 17 that uses the stray inductance (not shown in the figure) of the resonant capacitor C6, C7 and the second transformer T4 to produce a resonant sine wave; a second transformer T4 having its primary winding for inputting the resonant sine wave and its secondary winding for outputting a transformation sine wave to drive the light source device 18, and the light source device 18 could be a light source used in an LCD backlight module and includes a cold cathode fluorescent lamp 21, 22 respectively connected with the capacitor C2, C3 in series; and a feedback control circuit 19 that uses the transformation sine wave to produce a feedback to a feedback signal of the pulse width control circuit 16.

While the invention has been described by way of example and in terms of a preferred embodiment, it is to be understood that the invention is not limited thereto. To the contrary, it is intended to cover various modifications and similar arrangements and procedures, and the scope of the appended claims therefore should be accorded the broadest interpretation so as to encompass all such modifications and similar arrangements and procedures.

What is claimed is:

1. A light source driver circuit, comprising:
a pulse width control circuit, using an AC power supply for producing a square wave;
a first transformer, having a primary winding for inputting said square wave and a secondary winding for outputting a transformation square wave;
a resonant circuit, for inputting said transformation square wave to produce a resonance sine wave; and
a second transformer, having a primary winding for inputting said resonance sine wave and a secondary winding for outputting a transformation sine wave to drive a light source.

2. The light source driver circuit of claim 1, wherein said AC power supply is produced by city electricity through a rectifier filter.

3. The light source driver circuit of claim 1, wherein said pulse width control circuit uses a pulse width modulator to control two current switches to produce said square wave by means of a half-bridge, a full-bridge, a pull-push, or a transistor topology.

4. The light source driver circuit of claim 1, wherein said transformation square wave includes a low voltage complying with the requirements defined by safety regulations.

5. The light source driver circuit of claim 1, wherein said Resonant circuit is connected to said resonant circuit in parallel and connected to said resonant circuit or Class E in series for driving said resonant circuit of said light source.

6. The light source driver circuit of claim 1, wherein said light source comprises a cold cathode fluorescent lamp.

7. The light source driver circuit of claims 1, further comprising a feedback control circuit that uses said transformation sine wave to produce a feedback signal of said pulse width control circuit.

8. The light source driver circuit of claims 2, further comprising a feedback control circuit that uses said transformation sine wave to produce a feedback signal of said pulse width control circuit.

9. The light source driver circuit of claims 3, further comprising a feedback control circuit that uses said transformation sine wave to produce a feedback signal of said pulse width control circuit.

10. The light source driver circuit of claims 4, further comprising a feedback control circuit that uses said transformation sine wave to produce a feedback signal of said pulse width control circuit.

11. The light source driver circuit of claims 5, further comprising a feedback control circuit that uses said transformation sine wave to produce a feedback signal of said pulse width control circuit.

12. The light source driver circuit of claims 6, further comprising a feedback control circuit that uses said transformation sine wave to produce a feedback signal of said pulse width control circuit.
